(19) United States
(12) Patent Application Publication
(10) Pub. No.: US 2025/0061489 A1
(43) Pub. Date: Feb. 20, 2025

(54) SYSTEMS AND METHODS FOR MEDIA PLANNING USING ARTIFICIAL INTELLIGENCE

(71) Applicant: Gale Force Digital Technologies, Inc., West Palm Beach, FL (US)

(72) Inventors: Terence J. Murphy, West Palm Beach, FL (US); Jennifer Williams, Placitas, NM (US); Christopher Sommella, Royal Palm Beach, FL (US); Kendal Plume, West Palm Beach, FL (US); Brendan Carson, Palm Beach Gardens, FL (US); Kevin Fyffe, Indianapolis, IN (US); Heather Broda, Indianapolis, IN (US); Sergio Bello, Miami, FL (US); Yidielis Bello, Miami, FL (US); Reinier Milian, Palm Beach Gardens, FL (US); Hector Fuentes, Miami, FL (US)

(21) Appl. No.: 18/739,458

(22) Filed: Jun. 11, 2024

Related U.S. Application Data
(60) Provisional application No. 63/519,968, filed on Aug. 16, 2023.

(51) Int. Cl. G06Q 30/0251

(52) U.S. Cl. CPC G06Q 30/0254

(57) ABSTRACT

Systems and methods of providing media plans, such as media buys or media sells, across multiple media types by using a deep learning/natural language processing (artificial intelligence (AI) powered system and/or other machine learning models).

### CROSS REFERENCE TO RELATED APPLICATIONS

In accordance with 37 C.F.R. 1.76, a claim of priority is included in an Application Data Sheet filed concurrently herewith. Accordingly, the present invention claims priority to U.S. Provisional Patent Application No. 63/519, 968, entitled “SYSTEMS AND METHODS S FOR MEDIA BUYING AND PLANNING USING ARTIFICIAL INTELLIGENCE”, filed Aug. 16, 2023. The contents of the above referenced application are incorporated herein by reference in its entirety.

### FIELD OF THE INVENTION

Embodiments of the invention relate to systems and methods for media planning; and more particularly, to systems and methods of providing artificial intelligence (AI)-based media plans, such as media buys or media sells, across multiple media types.

### BACKGROUND OF THE INVENTION

Media planning, whether focused on media buying or media selling, involves the process of purchasing ad space and time on various platforms or channels, both digital (websites, social media) and offline (television radio, print). Media buying focuses on getting brands in front of an intended audience or market. Typically, the goal of media buying is to identify and buy ad space in the platforms that are relevant to the target audience. Media buyers are responsible for purchasing advertising space and time on behalf of clients, aiming to place ads in contexts that maximize audience reach and campaign effectiveness. Media buyers, therefore, analyze various media outlets, negotiate prices, and strategize on the best placements to ensure advertisements reaches their target demographic efficiently. Media sellers typically work for media outlets, such as television networks, radio stations, or digital platforms, and is tasked with selling advertising space or time to potential advertisers. Media selling, therefore, focuses on maximizing revenue for media outlets by presenting the value and reach of their advertising opportunities to potential buyers.

With a limited view into nascent or cross-platform patterns, human media buyers/sellers miss opportunities to best leverage media budgets when structuring media buys or media sells. Cross-platform marketing is cumbersome and, in most cases, data do not conform among the various media types. An untold number of factors can lead to a passing or failing media plan and, in the absence of technology that can help to collate and predict against these factors, buyers currently do not have the tools to avoid pitfalls.

Additionally, the media landscape is in a constant state of change and flux. New content, breakthrough technologies, changes in audience interests, and new generations of audiences are just a few of the things that can influence subtle changes in trajectory of the industry that eventually will lead to a large portion of the audience no longer being reachable through previously tried-and-true methods.

An AI that is built to not only understand and predict against the current landscape but also predict, long term, where the industry is headed would be a game changer and would provide on-going guidance that wouldn't be accessible through human-only work. As AI technology allows juggling of immense existing data sets and producing of immense new data sets to determine positive or negative correlations among a vast set of variables, the speed of discovery and the sheer depth of data correlations are far beyond the capabilities of the human user.

### SUMMARY OF THE INVENTION

Systems and methods of providing reliable plans/strategies, including media buys, media sells, or combinations thereof, across multiple media types, using artificial intelligence (AI), such as deep learning/natural language processing and/or other machine learning models are provided. The systems and methods using AI to generate media plans across one or more media types may provide recommendations relating specifically to media buys, media sells, or combinations thereof.

As media buys are typically focused on finding and securing advertising opportunities at the best price, AI generated media plans with media buy related recommendations in accordance with embodiments of the present invention may focus on researching, planning, and buying advertising space, with specific recommendations for audience targeting, campaign management, order (confirming the purchase of advertising on a particular platform), invoice management and reconciliation and post-buy management. Systems and methods of providing reliable plans/strategies in accordance with embodiments of the invention may be configured to streamline the process of campaign creation, spot (advertisement) placement and audience or market research. Accordingly, media buy recommendations developed by systems and methods in accordance with embodiments of the invention may leverage vast datasets to discover and recommend cost-effective and impactful ad placements, leverage predictive analytics to forecast audience behaviors and automate the creation of campaigns across media types. Embodiments of the invention, therefore, will assist media buyers, and subsequently their advertiser clients, in reaching desired or targeted audiences while optimizing budget allocation to maximize campaign returns. The result is a highly efficient, data-driven approach that allows media buyers to make informed decisions swiftly, ensuring their ad campaigns are both effective and economical.

As media sells are typically focused on managing and maximizing the value of the advertising space available for sale, AI generated media plans with media sell related recommendations in accordance with embodiments of the present invention may be designed to streamline the selling process, enhance inventory utilization, and provide insights into sales trends and opportunities by, managing ad inventories, setting rates, tracking sales performance, and generating proposals for advertisers.

In certain embodiments, a method for providing media plans across one or more media types comprises: providing, via an electronic device or electronic network, initial data useful for developing a media plan, said electronic device comprising at least one processor, memory, and one or more programs stored in said memory and configured to be executed by the one or more processors; training, by one or more processors, an artificial intelligence machine learning model that outputs a media plan recommendation based on information received or stored within one or more databases; and generating a media buy or media plan recommendation. The method may further include the artificial intelligence model being configured to learn and improve based on success or failure of previous recommendations compared to past user data. As such, the method may include repeatedly retraining the trained artificial intelligence machine learning model by adjusting the learned states according to the success or failure of previous recommendations generated. The media plan may be directed to media buys, media sells, or media buys and media sells.

In certain embodiments, a system for providing artificial intelligence (AI)-based media plans across one or more media types comprises: an electronic device comprising at least one processor, memory, and one or more programs stored in the memory and configured to be executed by said one or more processors; and a machine learning system that trains a machine learning model that outputs a media buy recommendation based on sored or obtained information relative to media buys or plans, wherein, the one or more programs stored in the memory preform the method of developing a media plan recommendation by: using or obtaining data useful for developing a media plan; training an artificial intelligence machine learning module using a training set of data associated with media buying or media; and generating, using the artificial intelligence machine learning module, a media buy recommendation. The media plan may be directed to media buys, media sells, or media buys and media sells.

Certain embodiments of the invention may include a tangible, non-transitory readable medium storing instructions that, when executed by one or more processors, cause the development of a media plan recommendation by: using or obtaining data useful for developing a media buy and/or media plan; training an artificial intelligence machine learning module using a training set of data associated with media buying or media; and generating, using the artificial intelligence machine learning module, a media plan recommendation.

Accordingly, it is an objective of the invention to provide systems and methods of providing reliable media planning/strategies.

It is an objective of the invention to provide systems and methods of providing reliable media planning/strategies directed towards a media buy.

It is an objective of the invention to provide systems and methods of providing reliable media planning/strategies directed towards a media sell.

It is an objective of the invention to provide systems and methods of providing reliable media planning/strategies directed towards a media buy and a media sell.

It is a further objective of the invention to provide systems of providing media plans utilizing artificial intelligence.

It is a further objective of the invention to provide systems of providing media buys utilizing artificial intelligence.

It is a further objective of the invention to provide systems of providing media sells utilizing artificial intelligence.

It is a further objective of the invention to provide methods of providing media plans utilizing artificial intelligence.

It is a further objective of the invention to provide methods of providing media buys utilizing artificial intelligence.

It is a further objective of the invention to provide methods of providing media sells utilizing artificial intelligence.

It is yet another objective of the invention to provide systems and methods of providing media plans utilizing an artificial intelligence algorithm that can analyze large data sets to identify patterns, trends, and insights in optimizing planning decisions.

It is yet another objective of the invention to provide systems and methods of providing media buys utilizing an artificial intelligence algorithm that can analyze large data sets to identify patterns, trends, and insights in optimizing media buying decisions.

It is yet another objective of the invention to provide systems and methods of providing media sells utilizing an artificial intelligence algorithm that can analyze large data sets to identify patterns, trends, and insights in optimizing media selling decisions.

It is a further objective of the invention to provide systems and methods of providing media plans utilizing an artificial intelligence algorithm that can utilize data sets, including ratings data, consumer behavior, and historical performance data, to provide predictive assessments of media platforms in local and national markets.

It is a further objective of the invention to provide systems and methods of providing media buys utilizing an artificial intelligence algorithm that can utilize data sets, including ratings data, consumer behavior, and historical performance data, to provide predictive assessments of media platforms in local and national markets.

It is a further objective of the invention to provide systems and methods of providing media sells utilizing an artificial intelligence algorithm that can utilize data sets, including ratings data, consumer behavior, and historical performance data, to provide predictive assessments of media platforms in local and national markets.

It is yet another objective of the invention to provide systems and methods of providing media plans utilizing an artificial intelligence algorithm that provides individual buys per media type, including traditional TV, cable TV, traditional radio, streaming TV, streaming audio, and all other media types.

It is yet another objective of the invention to provide systems and methods of providing media buys utilizing an artificial intelligence algorithm that provides individual buys per media type, including traditional TV, cable TV, traditional radio, streaming TV, streaming audio, and all other media types.

It is yet another objective of the invention to provide systems and methods of providing media sells utilizing an artificial intelligence algorithm that provides individual buys per media type, including traditional TV, cable TV, traditional radio, streaming TV, streaming audio, and all other media types.

It is a still further objective of the invention to provide systems and methods of providing media plans utilizing an artificial intelligence algorithm that can continuously learn and improve based on the success or failure of previous recommendations compared to past user data.

It is a still further objective of the invention to provide systems and methods of providing media buys utilizing an artificial intelligence algorithm that can continuously learn and improve based on the success or failure of previous recommendations compared to past user data.

It is a still further objective of the invention to provide systems and methods of providing media sells utilizing an artificial intelligence algorithm that can continuously learn and improve based on the success or failure of previous recommendations compared to past user data.

It is a further objective of the invention to provide artificial intelligence algorithms that can analyze large data sets and provide real-time or predictive recommendations for media planning.

It is a further objective of the invention to provide artificial intelligence algorithms that can analyze large data sets and provide real-time or predictive recommendations for media buying.

It is a further objective of the invention to provide artificial intelligence algorithms that can analyze large data sets and provide real-time or predictive recommendations for media selling.

It is yet another objective of the invention to provide a user platform that leverages the systems and methods of providing media plans utilizing an artificial intelligence to provide media buys and perform subsequent buys.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a schematic representation of an illustrative embodiment of a system of providing artificial intelligence (AI)-based media plans, such as media buys, across multiple media types;

FIG. 2 is a schematic illustration of AI learning/modeling associated with the system of providing artificial intelligence (AI)-based media plans, such as media buys, across multiple media types;

FIG. 3 is a flow chart of an illustrative embodiment of a method of generating an AI generated plan for individual buys for one media type;

FIG. 4 is a flow chart of an illustrative embodiment of a method of generating an AI generated media plans, such as media buys for a seltzer water product; and

FIG. 5 is a flow chart of an illustrative embodiment of a method of generating an AI generated media plan, such as a media sell for a target advertiser.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

Embodiments of the technology provide novel systems and methods of providing reliable media plans, including media buys or media sells, across multiple media types by using a deep learning/natural language processing (for example, artificial intelligence (AI) powered system and/or other machine learning models).

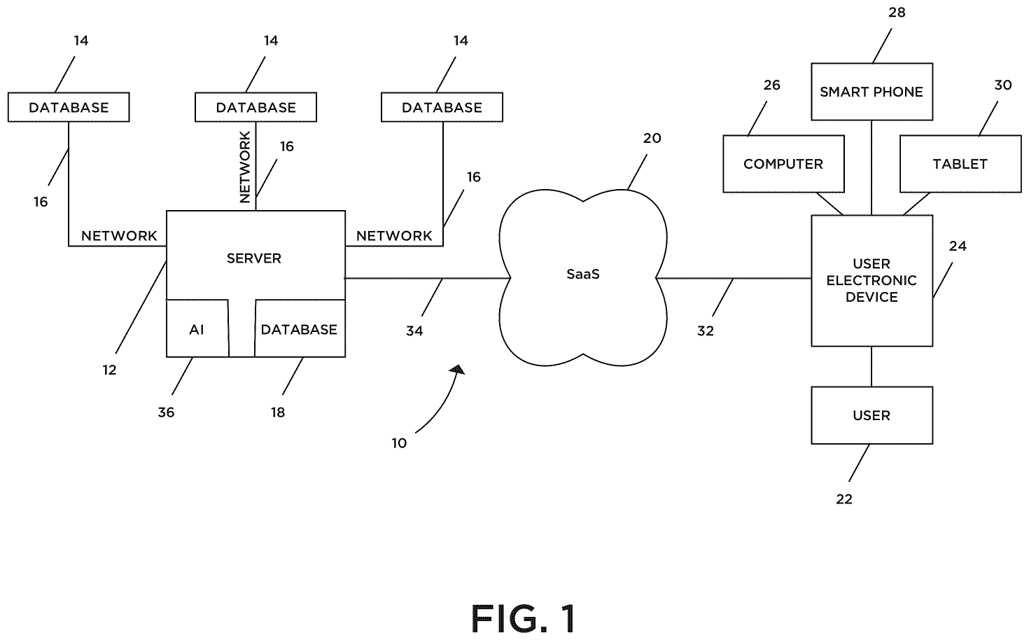

Referring to FIG. 1, an illustrative embodiment of a system of providing artificial intelligence (AI)-based media plans across multiple media types, referred to generally as an AI media planning system 10, is provided. The AI media planning system 10 includes the necessary hardware and software components to accomplish its intended functionality. Accordingly, the AI media planning system 10 may include one or more servers 12 for communication, data collection, and/or data processing. The one or more servers 12 may include one or more of processors, such as a central processing unit (CPU), memory (includes a volatile memory or a non-volatile memory, or may include both a volatile memory and a non-volatile memory; the non-volatile memory may be a read-only memory (ROM), and the volatile memory may be a random access memory (RAM)), storage, input controls, network interface, network communication modules (wired or wireless), and the necessary software to provide analysis and determinations of media plan options, including media buy options or media sell options. The necessary software which when executed, cause the processor to perform AI media planning system 10 functionalities. Accordingly, the software may include non-transitory, machine-readable medium storing instructions which when executed by at least one programmable processor, cause the programmable processor to perform operations, i.e., one or more functions associated with the AI media planning system 10 functionalities.

Operatively connected to the one or more servers 12 are one or more databases 14. The one or more databases 14 may store information from independent sources, i.e. a third party, and be connected to the data stored therein via a network 16 (cloud based or Internet). In addition to, or in combination with, the databases 14, the one or more servers 12 may contain its own internal database(s) 18. The AI planning system 10 may be provided as a software-as-a-service (Saas) 20 in which the AI media planning system 10 application is delivered to a user 22 utilizing an electronic device 24, such as a computer 26, a smart phone 28 (i.e. an IPHONE), or a computer tablet 30 (IPAD). The user can access the SaaS network 20 via the user's electronic device 24 via a network 32 (cloud based or Internet). The user 22 is operatively linked to the media buy and planning system 10 via the SaaS 20 through a network 34 (cloud based or Internet). Alternatively, a user 22 may download a software application having the AI media buy and planning system 10 to their own electronic device, such as a computer.

Data Collection and Preprocessing:

The AI media planning system 10 is designed to collect and pre-process a wide range of data, including historical media buying data, campaign performance metrics, audience demographics, media channel characteristics, budget constraints, and market trends. The data may be cleaned, standardized, and organized for subsequent analysis. The sources for these data will be varied, depending on the media type in question. For example, TV and Radio (“traditional” media) measurement may be derived from well-known measurement industry leaders while streaming audio and programmed (“non-standard” media) data may be derived from smaller sources specific to the media buyer.

The AI media planning system 10 is designed to use one or more AI algorithm(s) (or neural networks) that can 1) analyze large data sets to identify patterns, trends, and insights that can help optimize media planning decisions, including media buy decisions or media sell decisions 2) utilize data sets, including ratings data, consumer behavior, and historical performance data, to provide predictive assessments of media platforms in local and national markets, 3) offer individual buys or sells per media type, including traditional TV, cable TV, traditional radio, streaming TV, streaming audio, and all other media types, 4) offer overall media planning solutions, including media buying solutions or media selling solutions, that would suggest the best division of budget across platforms, % of content per platform, target demographic or psychographic per platform, and 5) continuously learn and improve based on the success or failure of previous recommendations compared to past user data. As such, the AI media planning system 10 may include repeatedly retraining the trained artificial intelligence machine learning model by adjusting the learned states according to the success or failure of previous recommendations generated.

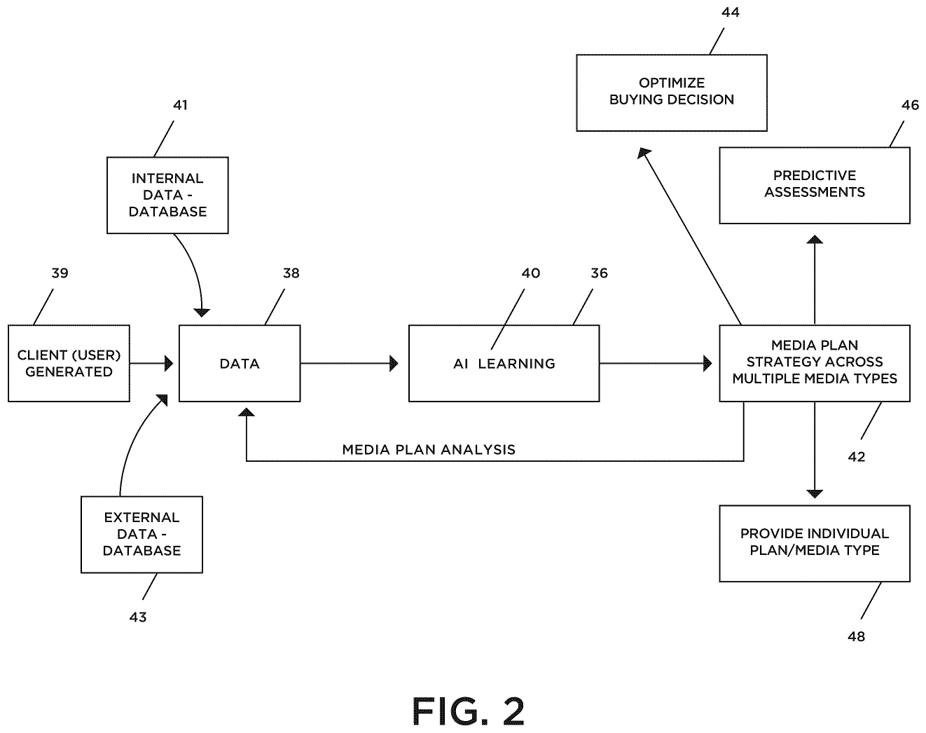

Accordingly, the predictive media planning recommendations, including buy recommendations (or sell recommendations), that would provide users with the option to create platform specific buys (for example, Traditional TV), but would also look across media platforms and make suggestions for the overall media plan, is accomplished using an AI modeling system 36. Referring to FIG. 2, a schematic representation of the AI modeling system is provided. Using data 38 from multiple sources (one or individually or in combination of, client generated 39, such geography, as budget, etc.; internal data/databases 41, such as past history associated with markets or buys; or external data/databases from independent, third parties 43, such as GOOGLE or Nielsen). The AI learning 40 is configured to provide media buy and/or media planning strategies 42, including but not limited to optimize media buying decisions, predictive assessments of media platforms in local and national markets 44, provide individual buys per media type 46, and provide overall planning solutions (including media buying and media selling solutions) 48.

The AI algorithm of the AI media planning system 10 may utilize one or more, in any combination, of machine learning models to optimize media buys and media plans:

Collaborative Filtering: Collaborative filtering techniques may be employed to identify patterns and similarities between media buys and campaigns. By analyzing historical data, the algorithm can recommend media buys based on multiple considerations, individually or in combination, such as on the success of similar campaigns, considering attributes like target audience, campaign goals, media channels, and budget.

Reinforcement Learning: Reinforcement learning algorithms enable the AI system to interact with the environment and learn optimal media buying strategies through trial and error. The algorithm explores different media buy configurations, evaluates their performance, and updates its models based on received rewards or penalties. This iterative learning process leads to improved media buy decisions over time.

Of particular importance is the AI's ability to assess “pass” vs. “fail” when considering past data and, in looking back, be able to identify the reason or reasons. This is another benefit that is unique to AI technology, as the cause is not always immediately evident to a human user in the absence of machine-based technology that can draw more nuanced conclusions. Many factors, large and small, could contribute to the level of success of a media plan or individual buy (or individual sell). The AI media planning system 10 is engineered to take into account multiple measurement data sets and make determinations based on a host of other factors, like time of year, local weather, local or national events, unexpected programming preemptions, and tracking the gradual shift of audiences to other platforms.

Deep Neural Networks: Deep neural networks are utilized to learn complex patterns and relationships within the media buying data. These networks can capture non-linear interactions among various factors, such as audience demographics, media channel effectiveness, and campaign objectives. The neural networks learn to predict the success of media buys and recommend optimal media plans based on the learned patterns. In post-review analysis, deep neural networks may be utilized to determine the underlying reasons for a “passed” or “failed” media plan or buy. By cataloging these reasons and incorporating them into its knowledge bank, the AI media planning system 10 is configured to continually produce additional intelligent predictive recommendations.

The AI media planning system 10 provides AI algorithms which undergo an initial training phase using a large dataset of historical media buying (or media selling) data and campaign outcomes. During training, the algorithm optimizes its machine learning models using techniques such as gradient descent and backpropagation. As the algorithm operates within the SaaS platform 20 and interacts with real-world data, it continually updates and refines its models to adapt to evolving market conditions and user preferences.

The AI media planning system 10 is designed to incorporate raw data to produce the most intelligent predictive assessment of media types and markets. In addition, the AI media planning system 10 includes learning which is cumulative and based on multiple factors important to media planning overall, and to media buys or media sells, such as reach, frequency, cost efficiency, and desired outcomes to generate well-rounded and effective media plans across diverse media types.

The AI algorithm of the AI media planning system 10 is designed to employ an iterative feedback loop to continuously improve the quality of media plans (including media buy and media sell quality). By monitoring media planning factors (such as media buy factors or media sell factors), such as campaign performance, collecting user feedback, and incorporating market insights, the algorithm refines its models, enhancing its ability to generate better media plans over time.

The AI media planning system 10 utilizes data stored in database(s) 14 (39, 41, 43) in generating real-time and/or predictive recommendations for media planning, such as media buying predictive recommendations or media selling predictive recommendations, or combinations thereof. The AI media planning system 10 utilizes algorithms which consider factors such as audience reach, engagement metrics, and budget constraints, as well as historical performance data and real-time behavioral data.

To provide predictive assessments of media platforms in local markets, as well as national markets, the AI media planning system 10 algorithm(s) leverages a variety of data sets, including ratings data, consumer behavior data, and historical performance data. These data sets will be used to provide a comprehensive view of media platforms and help users make informed decisions about where to place their ads. The datasets may be internal datasets or external datasets.

Internal Data Sets: Data sets that provide detailed profiles of past media buys (or sells). The internal data sets may be anonymized, thus providing historical perspective to the AI regarding choices made by media buyers. Data may be limited to information provided within worksheets (i.e. buys) and include details such as daypart, station or outlet, number of spots, rotations. Specifically, the AI will assess “pass/fail” across hundreds of thousands of existing media buys. Through comparing the target of each buy to its result, the AI will further hone its forecasting ability by judging whether the decisions made by those media buyers indeed reached the desired audience. Unlike a human user, the AI is capable of analyzing an enormous number of variables for statistical significance and establishing an acceptable, constantly evolving, threshold of success. As each new media buy is entered into the system, the causes for a delta between the target and the result will be appended to the AI's library of knowledge. The AI media planning system 10, for media buys, using AI, may be designed to integrate past choices made by buyers as well as leveraging the success of buys by incorporating “post buy” data, or the comparison between the projected success of a campaign versus the actual success based on ratings and audience delivery metrics.

Internal data sets related to media selling may include data tables of rates, avail packages (i.e. the collection of content sold to a particular advertiser), past line ups of standard and special programming. The AI media planning system 10, for media sells, using AI, may be designed to leverage past proposals, past rates that were accepted by advertisers (the final rate versus the proposed rate), post-sale analysis data, and other details to continue the learning

External Data Sets (Databases). To fully inform the AI, use of third party databases may be used individually or in combination with the Internal Data Sets. The External Data Sets include data from independent groups or organizations (commercial or governmental), which may also be referred to as data providers. Media plans for media buys are designed to access diverse and comprehensive datasets to optimize advertising buys and ensure maximum return on investment. In illustrate dataset may include, but not limited to, program ratings, which provide crucial insights into viewership patterns, demographics, and the overall popularity of various media content. This information helps media buyers to target their advertising to the most appropriate audiences, maximizing exposure and engagement. Additionally, the AI media planning system 10 may utilize datasets on consumer behavior and preferences, advertising costs, historical ad performance metrics, and competitive advertising activity. Digital media trends and online engagement metrics can also offer valuable insights into real-time consumer sentiments and emerging trends. Access to real-time data feeds on news events and cultural phenomena may also be vital, allowing media buyers to adapt strategies to capitalize on or avoid transient media environments. By integrating these diverse data sources into a cohesive media buying strategy, AI media planning system 10 delivers tailored advertising placements that are both cost-effective and impactful.

Illustrative examples of such data providers include, but are not limited to: Google Analytics (e.g. user conversion data), Comscore (media measurement and analytics company providing marketing data and analytics) or Nielsen (audience measurements, data, and analytics company), the FCC (Federal Communications Commission, United States, radio & TV data), Trans Union (credit reporting agency), Audigent (platform to provide brands with data and analytics), Experian (credit reporting agency), Scarborough (marketing research), National Oceanic and Atmosphere Administration (NOAA), Weather. com, Claritas (marketing data and analysis), Adstra (buyer indicator), Samba TV (television and movie viewer indicators), Foursquare (location based audiences), The NOD Group (retail and consumer data; point of sale), Clickagy (B2B and B2C intent data), Resonate (customer rights; apropos to product type, product name, client name), ZeroSum (automotive marketing data) and Prizm (data analysis).

Media plans for media sells rely on data sets that help optimize inventory pricing, attract advertisers, and effectively compete in the market. The AI media planning system 10 may utilize, for example, but are not limited to, detailed audience analytics, including viewership demographics, engagement rates, and content preferences, which help sellers demonstrate the value of their advertising slots to potential buyers. These data may be used to inform the best rate (i.e. Equally important are competitive market analysis data, which provide insights into how similar media entities price their inventory and the types of advertisers they attract. For media plans relating to media sells, the AI media planning system 10 may utilize data relating to or providing insights into advertising effectiveness, including metrics on ad recall, brand lift, and conversion rates, enabling them to prove return on investment (ROI) to advertisers. Illustrative data utilized to provide media plans for media sells may include: 1) media outlet schedule data (regular schedule and specials); 2) media outlet programming data (content descriptions, advertiser advisories, product placement); 3) quantitative viewership (ratings) data (e.g. daily Comscore or Nielsen data); 4) qualitative product or advertiser data; 5) qualitative market data (e.g. Scarborough).

One application of 3^{rd} party data would be to integrate a customer database, such as those found in common CRM software solutions. The AI would be designed to identify commonalities that could allow for better media planning and audience targeting. By sifting through the dataset to identify audience demographics and attributes and comparing them to available advertising methodologies, the AI would be able to determine the best ways to reach the target audience. The AI would then incorporate these findings with other data review methods to output a suggested plan.

In certain embodiments, the AI media planning system 10 may be configured to provide for autonomous buy/sell submissions. As a user provides the AI media planning system 10 various parameters required (i.e. budget, product, client) for the medial plan recommendation, an option would provide for the buy or sale proposal or be automatically created and submitted to one or more recipients. In the buy scenario, for example, the AI media planning system 10 would pick the stations and would automatically send the orders to those stations or station representatives.

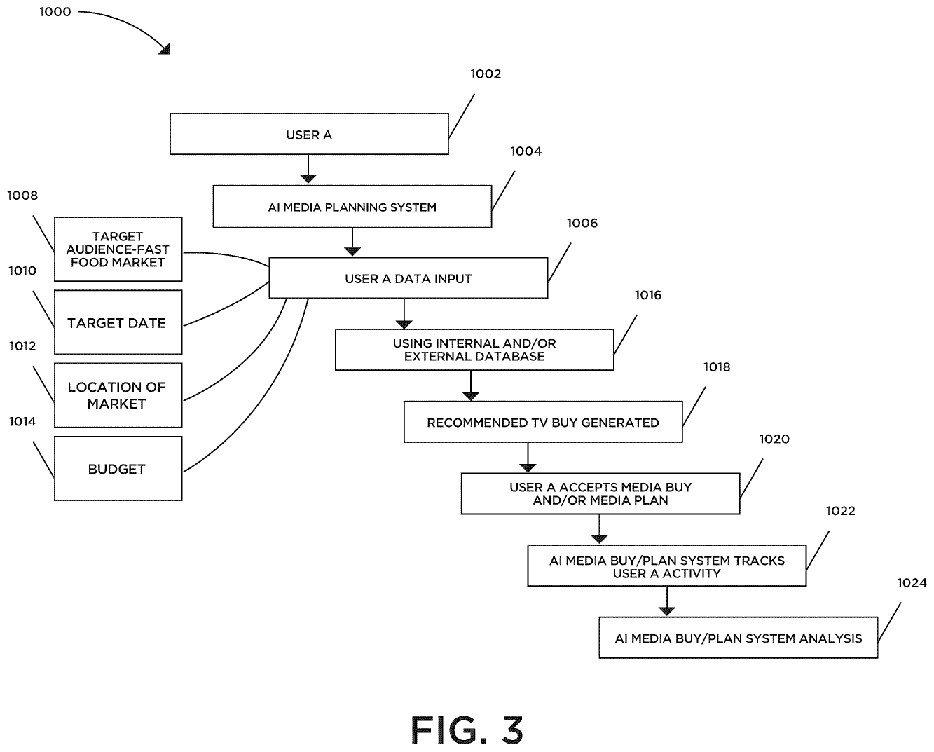

Referring to FIG. 3, an illustrative example of a method of generating a proposed media plan using AI, referred to generally as a method of generating an AI produced media plan 1000, is shown for individual buys for one media type. To provide flexibility to users, the method of generating an AI produced media plan 1000 is configured to offer individual buys per media type, including but not limited to traditional TV, cable TV, traditional radio, streaming TV, streaming audio, and podcasting. The AI algorithm of the AI media planning system 10 is configured to provide real-time or predictive recommendations based on data sets specific to each media type, automatically creating a buy for that platform within the criteria provided.

User A is planning to obtain a traditional television buy in the local Philadelphia DMA, see 1002. User A has a general idea of the target demographic, but uses the media planning system 10 to recommend placement, budget division, daypart assignment and flight dates, see step 1004. The media planning system 10 may be accessed via a SaaS platform. User A has initial data input to provide for developing a media buy and/or plan, 1006. This buy is intended to promote the launch of a new fast food chain (1008) that is having a grand opening on August 1st (1010) in a south side part of a city (1012). User A has a firm budget of $20,000 (1014). The budget covers the production of creative (i.e. the ads), as well as the cost of purchasing the TV time.

Leveraging internal and third party databases, as well as data reflecting past performance, 1016, the media planning system 10 produces a recommended TV buy for Philadelphia, 1018.
Spend: $15,000 on media, $5,000 on creative (two flavors of ads, no more are necessary)
Flight: 18 days prior to grand opening on August 1^{st}, continuing 5 days after grand opening (July 14th through August 6th)
Daypart: Saturday and Sunday Day, Monday and Wednesday Prime, Tuesday and Thursday Fringe
Avg CPM: $10, based on past data
Stations or Networks: WAAA-FM Philly, WBBB-FM Philly, Discovery Networks, ESPN

User A accepts, for the most part, the recommendations of the media planning system 10, see 1020. Given User A's experience with the Philadelphia market, User A decides to run spots in Saturday Prime, in addition to the dayparts mentioned above. The media planning system 10 is configured to keep track of the “human” activity as well, to further inform at least its data if not its learning 1022.

In October, it's time to post (i.e. compare the predicted buy performance to the actuals using third party databases). The media planning system 10 is configured to make a point by point comparison: 1) its own recommendation to the actuals, and 2) the buy with the “human” tweaks actuals, see 1024.

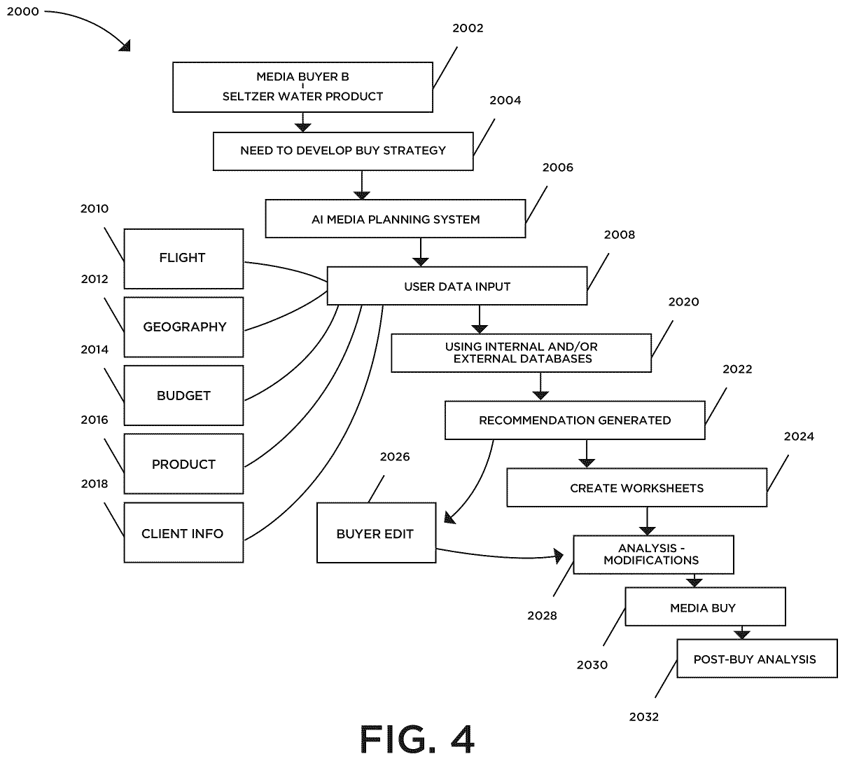

Referring to FIG. 4, an illustrative example of a method of generating a proposed AI produced media plan, referred to generally as a method of generating an AI produced media plan 2000, is provided. The method 2000 is used to provide media buys for a seltzer water product.

Media Buyer B has a consumer packaged goods (CPG) client launching a new product related to flavored, vitamin-enriched, seltzer water, see 2002. The client believes the product could be of interest to a variety of audience types. Media Buyer B has been requested to develop a media buying strategy considering multiple marketing venues and populations, with specific geographic targeting, 2004. Media Buyer B uses the AI media planning system 10 to develop a media buying strategy considering multiple marketing venues and populations with specific geographic targeting, see 2006.

Geography & Flight Dates: The client has secured distribution in Maryland and Delaware WALMART (department store selling commercial goods) and TARGET (department store selling commercial goods) stores, beginning Aug. 1, 2023.

Media Buyer B logs into the platform and begins the process, 2006. Media Buyer B first enters topline information, 2008:
Flight (2010): target date of Aug. 1, 2023
Geography (2012): zip codes of the various Walmart/Target stores in the Maryland and Delaware area
Budget (2014): Total media budget, including funds that would be set aside for creation of marketing materials
Product (2016): type of product, in this case health food/beverage CPG
Client (2018): company name

The AI media buy and planning system 10 may be taught to make recommendations and predictions by referencing a large variety of data sets, see 2020. In this case, the AI media planning system 10 considers all of the parameters entered by the media buyer and produces the following:

Flight: The AI media planning system 10 recommends flight dates based on the following, see 2022:

Audience Thresholds: The AI media planning system 10 considers past audience levels during the August 1st time frame. This includes, but is not limited to, households using televisions (HUTs)/persons using televisions, Daily Quarter-Hour Persons (AQH) (radio), Traffic (web), Downloads (apps and podcasts)

Reach: based on the above, the AI media planning system 10 establishes an acceptable Reach level and the best number of days beforeafter the product launch

Geography: Leveraging various sets of CPG/Big Box Point of Sale and Qualitative “foot traffic” data in the Maryland and Delaware area, the AI media planning system 10 recommends three types of geography for this buy:
Designated Markets (DMA) (traditional broadcast and out of home advertising (OOH))
Cable Zones (cable TV)
IP and Zip Code Arrays (digital)

Budget: Since the media buyer has entered the full budget, the AI media planning system 10 recommends a spend that will make the best use of the investment. For example: 1) Collateral: The time period indicates that achieving an acceptable Frequency will require a longer flight date. For this reason, it's unnecessary to over-produce a large variety of creative. Rather, the AI media buy and planning system 10 recommends that the media buyer consider producing no more than two (2) versions of creative with a focus on :15 and :30 audio/video ads and high-resolution, static, images for distribution on digital platforms and OOH.

Media Type: the AI media planning system 10 recommends that ad spent focus more than usual on audio platforms, digital platforms and OOH based on the following:

Audience expectations for that location and time period, especially lower primetime TV viewing levels during the summer months,

Past point of sale data also indicates a higher-than-usual percentage of buyers in these types of stores in these areas are from out of town (likely due to vacation migrations). This information leads the AI media buy and planning system 10 to recommend:

Media Real Estate: Recommending Specific Dayparts, OOH Locations and Content Outlets based on the following:

Purchase data suggests that potential buyers of this type of product are most likely to shop late mornings on Saturday or Sunday mornings,

Qualitative data suggests that the ideal target audience is generally affluent and holds a higher-level education. They are likely between the ages of 28 and 42. Gender has not proven to be a determining factor, but the majority have a young child or children in the home.

Client (Past Buys): In addition to the above, the AI media planning system 10 is taught to look for previous buys made by this media buyer for either this client, or a similar client selling a similar product, during a similar time period. It will review these buys, identify areas where those buys succeeded or failed, and apply, as necessary, these learnings to the new recommendation(s).

Results: The AI media buy and planning system 10 determines that the audience, geography, product, and time of year require a media plan that invests less than usual in traditional television. Rather, the AI media planning system 10 predictive algorithm(s) suggest that a larger TV buy would be a waste of money and that those funds would be much more effective on other media platforms.

Based on these findings, the following budget allotment and media plan is suggested.

If the media buyer accepts the recommendation, the next step will be creation of the individual buy. The AI creates a “worksheet”, which is a software-enabled table of data that comprises the buy (daypart, flight dates, content provider, market, CPM, ratings/metrics). This table is used to produce the “order” that is eventually sent to the content provider. If the buyer does not accept the recommendations, the buyer can make edits, 2026, and the AI media planning system 10 will automatically funnel them through the next step.

The AI media planning system 10 is configured to record the differences between the recommendations and any edits made by the media buyer. This will be compared, in post-buy analysis, and used for future interpretation, 2028.

### Flight Dates:

Jul. 5, 2023 through Aug. 8, 2023
Geography: DMAs: Philadelphia (DMA #4), Salisbury/Dover (DMA #144), Baltimore (DMA #28), and Washington DC (DMA #9)
The AI media planning system 10 recommends stations/programs within these DMAs

IP Array & Zip Codes: within 30-mile radius of each Walmart and Target Budget Divide:

### 15% Creative

Two versions of creative;: 15 and: 30 spots for TV\Radio\Digital and high-res images for digital and OOH

### 15% TV (Including Cable)

Few, if any, placements during primetime
Focus on Weekend Morning dayparts
The AI media buy and planning system 10 recommends specific programs, including Children's programming:

### 30% Radio (Including Streamed Audio Stations)

Morning/Evening drivetime

### 20% Digital

Targeted by Geography (IP address and Zip Code)
The AI media planning system 10 recommends three “psychographic” Programmatic targets, rather than specific sites or platforms

### 20% OOH:

30-mile radius of each store, special attention paid to beach, beach traffic and public pools. Outlets should include traditional highway/freeway signage.

Individual Media Buys, 2030: Once the above has been approved by the Media Buyer B, the AI media planning system 10 is configured to produce media sheets, and produces 4 media worksheets: TV (including cable), Radio, Digital (including audio streaming) and OOH.

The produced worksheets will cover the established flight dates and, as appropriate, spot counts will be added to each week to maximize coverage and achieve an adequate reach and frequency. Based on the prediction, daypart and location targeting will also be included.

The Media B Buyer may ask the AI media planning system 10 to assess a reasonable CPM based on the expected return. If the media buyer has already negotiated price with the media outlets, the media buyer can make their own edits to the worksheet and proceed through the ordering process.

Post-Buy Analysis, 2032: As the AI media planning system 10 is designed to continuously learn and continue to refer to new, refreshed, data sets to make predictive recommendations, the AI media planning system 10 is designed to look back in order to continuously learn and improve based on the success or failure of previous recommendations compared to past user data. By reviewing post-buy data (TV/Radio data, digital data, sales, and conversion data), the AI media planning system 10 assesses its own recommendations and add learnings for future reference. If, for example, the edits made by the media buyer produced a higher R&F than its own recommendation would have, the differences will be analyzed and stored for future use (part of the databases 14).

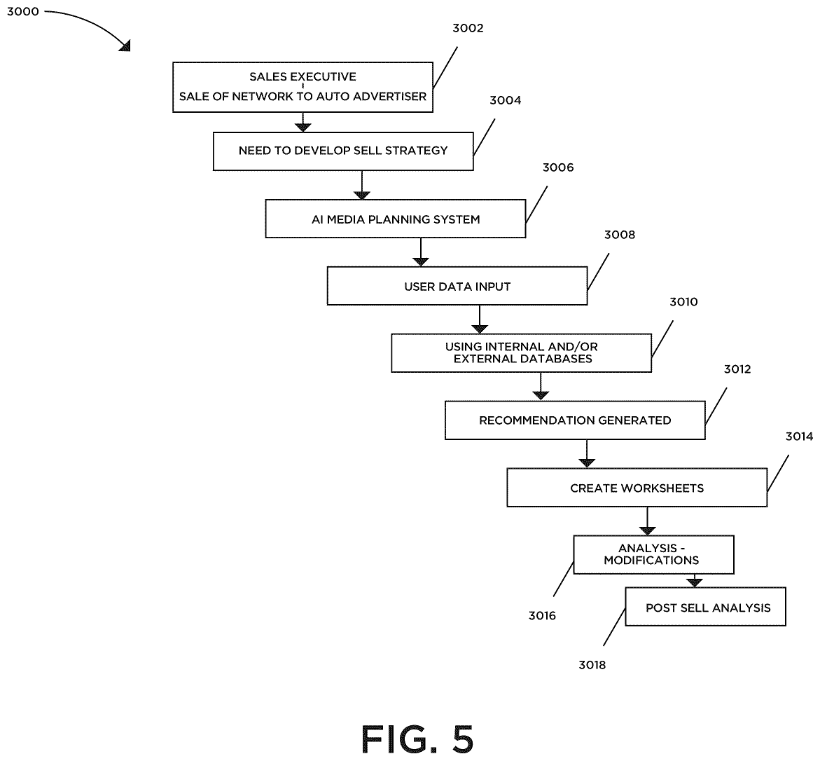

Referring to FIG. 5, an illustrative example of a method of generating a proposed AI produced media plan with media sell recommendations, referred to generally as a method of generating an AI produced media plan 3000, is provided. The method 300 is designed to utilize the AI media planning system 10 to generate a media outlet sales proposal. Utilizing the AI media planning system 10, the method 3000 is designed to integrate vast and seemingly disparate data sets to develop a network sales proposal for a target advertiser. The sell recommendations generated may include incorporation of programming schedules, past ratings data, available inventory, market and qualitative product/category data to produce a data-driven and customized proposal.

User C, a sales executive, is planning to pitch a full upfront sale of Network A to a gold card automotive advertiser, 3002. Besides the traditional marketing of the newest models of existing cars, this advertiser is also promoting their first fleet of fully electric vehicles. User C is charged with producing a proposal that markets existing products, i.e. the current fleet of cars, and successfully markets an entirely new product to possibly a different demographic, such as new electric vehicles, 3004. By incorporating a generous number of data sets into its decision making, the media planning system 10 (3006, 3008, 3010) would be utilized to suggest real estate and audience targets for both. The media planning system 10 would develop an annual proposal that leverages the following:

Schedule: Available Upfront Inventory, including tent pole specials and preemptions, that would be appropriate for the advertiser and products.

Ratings: Past program or time slot data that successfully reached the target audience.

Composite Audience: Qualitative data providing guidance on continuing psychographic targets, as well as new targets.

Product Data: Qualitative data providing guidance on the overall automotive category, including electric vehicles

Avg CPM: $550, based on past sales data and projected ratings during upfront programming.

Once the AI media planning system 10 creates the worksheet proposal for the seller, User C will have the option to accept or edit the results (3012, 3014, 3016). In keeping with the learning-driven framework, the media planning system 10 will notice and consider the differences and incorporate them into its data bank for future proposals.

Throughout the coming upfront year, and as these series, specials and preemptions air, the AI media planning system 10 would be designed to perform post sell analysis, and continually compare the ratings results to its initial recommendation, 3018. By leveraging the as-aired logs, as well as the air planned break format, the AI media planning system 10 can also compare the placements of the ads within the breaks.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures, and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method for providing media plans across one or more media types comprising:
providing or obtaining, via an electronic device or electronic network, initial data useful for developing a media plan, said electronic device comprising at least one processor, memory, and one or more programs stored in said memory and configured to be executed by said one or more processors;
training, by one or more processors, a machine learning model that outputs a media plan recommendation based on information received or stored within one or more databases; and
generating a media plan recommendation.

2. The method of claim 1, wherein said generated media plan recommendation is displayed on said electronic device or sent to a second electronic device via said electronic network.

3. The method of claim 1, wherein said artificial intelligence model is configured to optimize media plan decisions by analyzing data sets to identify patterns or trends.

4. The method of claim 1, wherein said artificial intelligence model is configured to provide individual buys per media type.

5. The method of claim 1, wherein said media buys or plans includes a recommendation to purchase advertising space on one or more platforms.

6. The method of claim 5, wherein said on one or more platforms are digital platforms, non-digital platforms, or combinations thereof.

7. The method of claim 6, wherein said on one or more digital platforms or non-digital platforms include websites, social media, television, radio, or print.

8. The method of claim 1, wherein said artificial intelligence model is configured to learn and improve based on success or failure of previous recommendations compared to past user data.

9. The method of claim 1, wherein said media buy recommendation or said media plan recommendation is generated using information related to ratings data, consumer behavior, historical performance data, or combinations thereof.

10. The method of claim 1, wherein said artificial intelligence model is configured to provide real-time recommendations for media planning.

11. The method of claim 1, wherein said media buys or plans includes a recommendation to purchase advertising time or purchase advertising space on one or more platforms.

12. The method of claim 11, wherein said on one or more platforms are digital platforms, non-digital platforms, or combinations thereof.

13. The method of claim 12, wherein said on one or more digital include platforms or non-digital platforms websites, social media, television, radio, or print.

14. The method of claim 1, wherein said artificial intelligence model is configured to provide predictive assessments of media platforms in local markets, national markets, or combinations thereof.

15. A system for providing artificial intelligence (AI)-based media plans across one or more media types comprising:
an electronic device comprising at least one processor, memory, and one or more programs stored in said memory and configured to be executed by said one or more processors; and
a machine learning system that trains a machine learning model that outputs a media plan recommendation based on sored or obtained information relative to media plans,
wherein, said one or more programs stored in said memory preform the method of developing a media buy and/or media plan recommendation by:
use or obtain data useful for developing said media plan;
train an artificial intelligence machine learning module using a training set of data associated with media said media planning;
generating, using said artificial intelligence machine learning module, said media plan recommendation.

16. The system of claim 15, further including one or more databases for receiving or storing said information for use in developing said media plans.

17. The system of claim 16, wherein said one or more databases may include external data sets.

18. The system of claim 16, wherein said one or more databases may include internal data sets.

19. The system of claim 15, further including a second electronic device operatively connected to said electronic device via an electronic network.

20. A tangible, non-transitory readable medium storing instructions that, when executed by one or more processors, cause the development of a media plan recommendation by:
using or obtaining data useful for developing said media plan;
training an artificial intelligence machine learning module using a training set of data associated with media planning; and
generating, using said artificial intelligence machine learning module, said media plan recommendation.
